(19) United States
(12) Patent Application Publication
(10) Pub. No.: US 2012/0032908 A1
(43) Pub. Date: Feb. 9, 2012

(54) METHOD FOR PROVIDING USER INTERFACE (UI) TO DETECT MULTIPOINT STROKE AND MULTIMEDIA APPARATUS USING THE SAME

(75) Inventors: Jong-Sung JOO, Seongnam-si (KR); Bo-eun PARK, Seongnam-si (KR); Jung-geun KIM, Suwon-si (KR)

(73) Assignee: SAMSUNG ELECTRONICS CO. LTD., Suwon-si (KR)

(21) Appl. No.: 13/272,456

(22) Filed: Oct. 13, 2011

Related U.S. Application Data
(63) Continuation of application No. 12/165,891, filed on Jul. 1, 2008.

(30) Foreign Application Priority Data
Jan. 24, 2008 (KR) 10-2008-0007562

(51) Int. Cl. G06F 3/041

(52) U.S. Cl. 345/173

(57) ABSTRACT

A method for providing a user interface (UI) and a multimedia apparatus using the same in which, if a multipoint stroke in which at least two strokes are concurrently input is detected on the touch screen, the touch screen performs a function corresponding to the multipoint stroke. A user can touch the touch screen to perform functions of various types using such a multipoint stroke.

### PRIORITY

This application is a continuation of U.S. patent application Ser. No. 12/165,891, filed Jul. 1, 2008, which claims the benefit of Korean Patent Application No. 10-2008-0007562, filed on Jan. 24, 2008 in the Korean Intellectual Property Office, the disclosure of which is incorporated herein by reference.

### BACKGROUND OF THE INVENTION

1. Field of the Invention

Aspects of the present invention relate to a method for providing a user interface (UI) and a multimedia apparatus using the same, and more particularly, to a method for providing a UI to detect that a user's input via a touch input device, and a multimedia apparatus using the same.

2. Description of the Related Art

Multimedia apparatuses, such as MPEG-1 audio layer 3 (MP3) players, have become widely used. Therefore, such multimedia apparatuses are fabricated for convenient use. Accordingly, such multimedia apparatuses generally include a display and provide a UI using a graphical user interface (GUI).

GUI methods generally use pointing devices to select items, such as icons or menus on a screen of a display. A user may input commands through the GUI using input devices, such as, a mouse, a touch pad, or a touch screen. The user may select desired content using the input device, and may view, listen to, or otherwise use the content.

A touch screen receives user operations input when a user touches buttons displayed on a screen. The user of such a touch screen may thus use the UI more intuitively. However, the touch screens are subject to greater limitations than keyboards when inputting commands. The keyboard has a plurality of keys, and thus a user can assign shortcut keys to certain functions. However, touch screens are sometimes the only input method that may be used to carry out certain functions.

Users require a more convenient interface, and thus a method which enables a user to use a touch screen more conveniently is required.

### SUMMARY OF THE INVENTION

Aspects of the present invention relate to a method for providing a UI which displays a guide for functions performed according to user operations and which enables a user to use a touch screen more easily.

According to an aspect of the present invention, there is provided a method for providing a user interface (UI), including detecting a multipoint stroke on a touch screen; and performing a function corresponding to the multipoint stroke upon detection of the multipoint stroke, wherein the function corresponding to the multipoint stroke is determined according to a number of concurrent touches of the touch screen.

According to an aspect of the present invention, the function corresponding to the multipoint stroke may be distinct from that of a single-point stroke.

According to an aspect of the present invention, the multipoint stroke comprises a touch of the touch screen at multiple points on the touch screen.

According to an aspect of the present invention, the performing may include displaying items related to currently displayed items at an area in which the multipoint stroke is detected when the multipoint stroke is performed on the touch screen from an edge of the touch screen towards a center of the touch screen.

According to an aspect of the present invention, the function corresponding to the multipoint stroke may include dividing a display area on the touch screen and displaying the items related to the currently displayed items on the divided area.

According to an aspect of the present invention, the function corresponding to the multipoint stroke may include displaying higher items or lower items corresponding to an item selected from the items displayed on the touch screen.

According to an aspect of the present invention, the function corresponding to the multipoint stroke may include displaying a menu of functions supported in a current state of operation of the UI.

According to an aspect of the present invention, the function corresponding to the multipoint stroke may include scrolling through a list of items of a higher level than a list displayed on the touch screen.

According to an aspect of the present invention, the function corresponding to the multipoint stroke may include changing a location of an item selected from a list displayed on the touch screen within the list.

According to an aspect of the present invention, there is provided a multimedia apparatus, including a touch screen display to detect a multipoint stroke; and a control unit responsive to the touch screen display to perform a function corresponding to the multipoint stroke if the multipoint stroke is detected, wherein the function corresponding to the multipoint stroke is determined according to a number of concurrent touches of the touch screen.

According to an aspect of the present invention, the determined function corresponding to the multipoint stroke may be distinct from that of a single-point stroke.

According to an aspect of the present invention, the determined function corresponding to the multipoint stroke may be determined according to a number of fingers used in stroking the touch screen.

According to an aspect of the present invention, the control unit may control the touch screen to display items related to currently displayed items at an area in which the multipoint stroke is detected if the multipoint stroke is performed on the touch screen from an edge of the touch screen towards a center of the touch screen.

According to an aspect of the present invention, the determined function corresponding to the multipoint stroke comprises dividing a display area on the touch screen and displaying the items related to the currently displayed items on the divided area.

According to an aspect of the present invention, the determined function corresponding to the multipoint stroke may include displaying higher items or lower items corresponding to an item selected from the items displayed on the touch screen.

According to an aspect of the present invention, the determined function corresponding to the multipoint stroke may include displaying menus regarding functions which are supported in a current state of the multimedia apparatus.

According to an aspect of the present invention, the corresponding to the multipoint stroke may include scrolling through a list of a higher level than a list displayed on the touch screen.

According to an aspect of the present invention, the determined function corresponding to the multipoint stroke may include changing a location of an item selected from a list displayed on the touch screen within the list.

According to an aspect of the present invention, there is provided a multimedia apparatus, including a touch input device to detect a multipoint stroke; a control unit responsive to the touch input device to perform a function corresponding to the multipoint stroke if the multipoint stroke is detected, wherein the function corresponding to the multipoint stroke is determined according to a number of concurrent touches of the touch screen.

According to an aspect of the present invention, the touch input device may be a touch pad.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an MPEG-1 audio layer 3 (MP3) player according to an exemplary embodiment of the present invention;

FIG. 2 is a flowchart illustrating the process of performing a function corresponding to a multipoint stroke by a user according to an exemplary embodiment of the present invention;

FIGS. 3A and 3B are views illustrating screens on which a music album list is displayed when a multipoint stroke is detected according to an exemplary embodiment of the present invention;

FIGS. 4A and 4B are views illustrating screens on which highlighting moves when a single-point stroke is detected according to an exemplary embodiment of the present invention;

FIGS. 5A and 5B are views illustrating screens on which a text mode menu is displayed when a multipoint stroke is detected according to an exemplary embodiment of the present invention;

FIGS. 6A and 6B are views illustrating screens on which a photographic mode menu is displayed when a multipoint stroke is detected according to an exemplary embodiment of the present invention;

FIGS. 7A, 7B, and 7C are views illustrating screens on which a user may scroll through a music album list when a multipoint stroke is detected according to an exemplary embodiment of the present invention; and

FIGS. 8A and 8B are views illustrating screens on which the position of a selected music file is moved when a multipoint stroke is detected according to an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

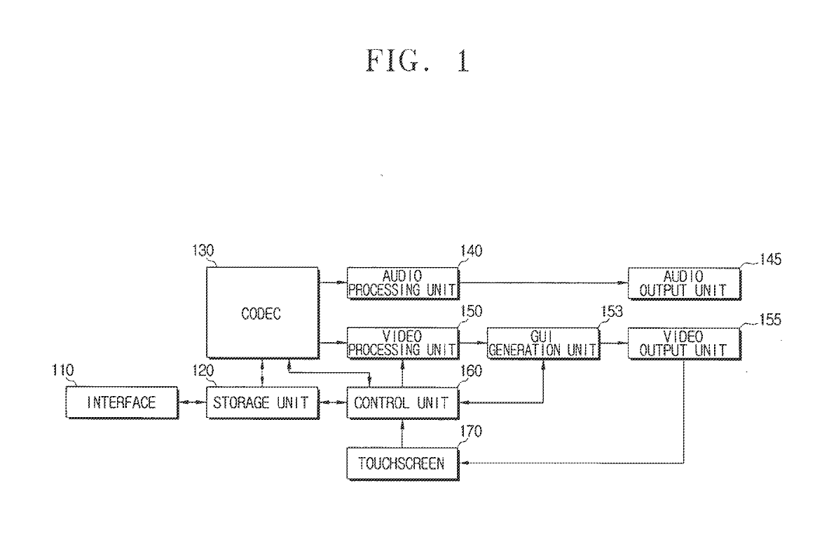

FIG. 1 is a block diagram illustrating an MPEG-1 audio layer 3 (MP3) player according to an exemplary embodiment of the present invention. Referring to FIG. 1, an MP3 player may include an interface 110, a storage unit 120, a codec 130, an audio processing unit 140, an audio output unit 145, a video processing unit 150, a graphical user interface (GUI) generation unit 153, a video output unit 155, a control unit 160, and a touch screen 170. Although described herein as an MP3 player, aspects of the present invention are not limited thereto such that aspects of the present invention may be applied to any touch screen device, such as a personal, laptop, or tablet computer having a touch screen, a phone, or other handheld or mobile device having a touch screen. Further, the encoding is not limited to MP3 but can be unencoded content or content encoded using other coding techniques, such as AAC. Moreover, the multimedia device can have other elements in addition to or instead of the shown elements, such as video encoders and decoders, buttons, optics of use in capturing images, etc.

The interface 110 enables the MP3 player to access a computer. The MP3 player downloads multimedia files stored on a computer (not shown) via the interface 110, and uploads multimedia files to the computer via the interface 110. According to aspects of the present invention, the interface 110 is not limited to accessing a computer as the interface 110 may provide connectivity to wired or wireless networks, cellular networks, other MP3 players, handheld devices, cellular phones, peripheral devices on a network, and the like.

The storage unit 120 of the MP3 player stores multimedia files, such as music files, video files, text files, or the like. The storage unit 120 may also store operational programs to operate the MP3 player. Further, according to aspects of the present invention, the storage unit 120 may further include executable programs or code other than the operation programs, such as widgets, third-party programs and functions, or internet executable programs and can comprise removable and/or internal memory.

The codec 130 compresses or decompresses multimedia files. Specifically, the codec 130 decompresses multimedia files stored in the storage unit 120, and transmits the decompressed multimedia files to the audio processing unit 140 or the video processing unit 150. The codec 130 may encode raw content to be stored in the storage unit 120 in other aspects of the present invention.

The audio processing unit 140 processes audio signals transmitted from the codec 130. For example, the audio processing unit 140 processes audio signals by performing noise reduction, equalization, or the like, and transmits the processed audio signals to the audio output unit 145. The audio output unit 145 outputs audio signals transmitted from the audio processing unit 140 through a speaker, headphone, or other audio output connected to an external output terminal.

The video processing unit 150 processes video signals transmitted from the codec 130 by performing video scaling or the like. The video processing unit 150 transmits the processed video signals to the GUI generation unit 153. The GUI generation unit 153 generates a GUI to be displayed on a display (such as the touch screen 170) together with video transmitted from the video processing unit 150. The video output unit 155 displays video together with the GUI output from the GUI generation unit 153 on the touch screen 170, or outputs the video to an external apparatus connected to an external output terminal (not shown). The touch screen 170 displays video output from the video output unit 155. The touch screen 170 receives a touch operation from a user, and transmits the touch operation to the control unit 160. Specifically, the touch screen 170 detects a ‘multipoint stroke’ touch in which more than two strokes are input concurrently.

The multipoint stroke represents an action in which a user touches at least two areas of the touch screen 170 using at least two fingers. For example, if the user strokes the touch screen 170 with two fingers, this action is a multipoint stroke. Although described as fingers, the touches of the touch screen 170 are not limited thereto such that other instruments may be used to touch the touch screen 170.

The touch screen 170 detects if a user touches at least two areas concurrently. If the touch screen 170 detects that strokes are input on at least two areas, the touch screen 170 transmits a signal indicating that the multipoint stroke is input to the control unit 160.

The control unit 160 recognizes a user command according to user's input transmitted through the touch screen 170 and controls the overall operation of the MP3 player according to the user command. Further, the control unit 160 recognizes user commands other than the touch operation, such as input commands input through a mouse, a keyboard, a microphone (i.e., for vocal commands), and the like. Further, according to aspects of the present invention, a stroke may be just a movement of the user's finger across the touch screen 170, the speed of which may be adjusted by the user such that the control unit 160 may recognize multipoint or single-point strokes of differing speeds to perform different functions or the same function but associated with a slower or faster stroke. Additionally, according to aspects of the present invention, the control unit 160 may recognize differing user's touching movements, such as a circle, or recognize multiple strokes to access one function, such as two strokes in an “X” pattern or an “III” pattern to access one function.

If the touch screen 170 detects a multipoint stroke, the control unit 160 causes functions corresponding to the multipoint stroke to be performed. There are no limitations on what functions may be performed corresponding to the multipoint stroke, but the functions corresponding to the multipoint stroke may be distinct from those of single-point strokes in which a user strokes an area of the touch screen 170 with one finger.

The function of a multipoint stroke performed under the control of the control unit 160 will be explained in detail with reference to FIG. 2. FIG. 2 is a flowchart illustrating the process of performing a function corresponding to a multipoint stroke by a user according to an exemplary embodiment of the present invention. In FIG. 2, the touch screen 170 detects user input (8210). If the user touches an area on the touch screen 170, the touch screen 170 transmits information regarding coordinates of the touched area to the control unit 160. If the user touches at least two areas on the touch screen 170 concurrently, the touch screen 170 transmits information regarding the coordinates of the at least two touched areas to the control unit 160.

Accordingly, the control unit 160 may detect whether two or more strokes input on the touch screen 170 (S220). If the touch screen 170 detects the multipoint stroke thereon (S220-V), the control unit 160 displays a list of a higher level than the list being displayed on the touch screen 170 (S225).

If the multipoint stroke is detected on the touch screen 170 starting near the edge and moving toward the center, the control unit 160 causes a higher list containing other items related to items currently being displayed to appear in the direction of the multipoint stroke.

In a case in which the multipoint stroke is detected, the control unit 160 may divide the screen area of the touch screen 170 and cause a higher list containing other items to be displayed on a portion of the screen.

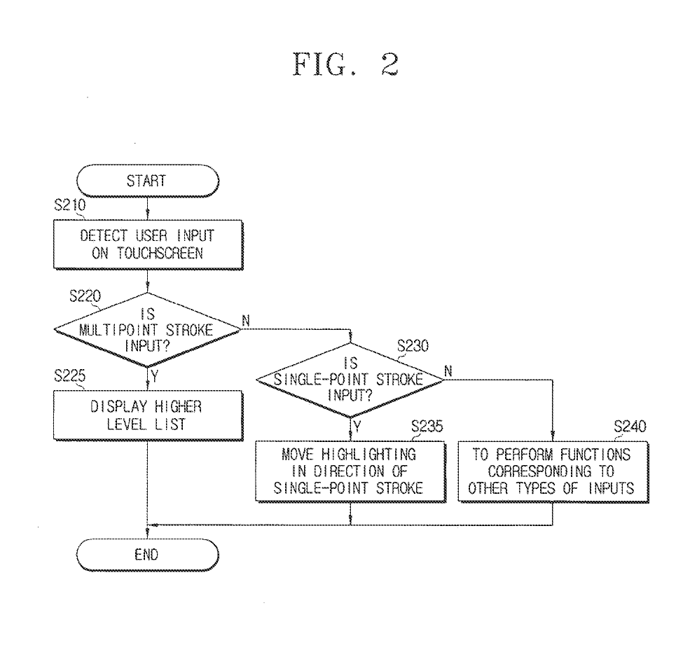

The exemplary embodiment of above description will be explained in detail with reference to FIGS. 3A and 3B. FIGS. 3A and 3B are views illustrating a screen on which a music album list is displayed when a multipoint stroke is detected according to an exemplary embodiment of the present invention. Referring to FIG. 3A, a music list 312 is displayed on a first screen 310, and highlighting 315 is displayed on a fifth music file of the music list 312. If a user inputs a multipoint stroke on a bottom area of the first screen 310 with two fingers, a second screen 320 appears, as shown in FIG. 3B. Image icons representing a music album list 325 higher than the current music list 312 is displayed on the second screen 320.

The music album list 325 appears when the user strokes the bottom area of the first screen 310. As the user strokes the touch screen 170 from the bottom area upward, that is, from the outside to the inside or the periphery toward the center, the music album list 325 appears from the bottom portion of the screen 320. Further, the music album list 325 may appear in whole or expand from an edge of the touch screen 170 as if the music album list 325 is being drawn out of the edge of the touch screen 170.

The music album list 325 is displayed on a portion of the area on which the music list 312 is displayed. As the music album list 325 and the music list 312 are both displayed on the screen concurrently, the user can view the two lists simultaneously at a glance.

The user can view and change the higher level music album list 325 more conveniently than the music list 312 being displayed through the above operation. The music album list 325 appears at an area in which the multipoint stroke is input from the direction of the input multipoint stroke, so the user may more intuitively check the music album list 325. Specifically, in FIGS. 3A and 3B, the user input a multipoint stroke from an area near the bottom toward the center of the first screen 310 so that the music album list 325 is displayed near the bottom of the second screen 320. However, aspects of the present invention are not limited thereto such that the use could input a multipoint stroke from another area toward the center of the first screen 310 so that the music album list 325 is displayed near the other area of the second screen 320. For example, the user could input a multipoint stroke from the left side toward the center of the first screen 310 so that the music album list 325 is displayed near the left side of the second screen 320.

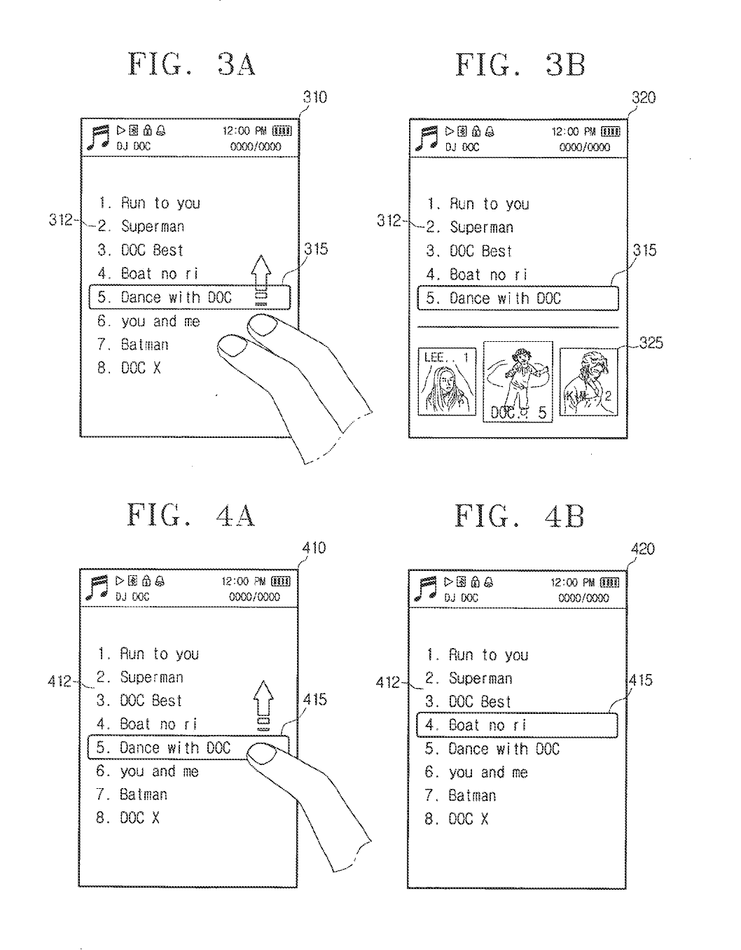

Returning to FIG. 2, if the touch screen 170 detects a single-point stroke (S230-Y), (i.e., does not detect a multipoint stroke (S220-N)), the control unit 160 controls highlighting to move in a direction in which the single-point stroke is input (S235), which will be explained in detail with reference to FIGS. 4A and 4B.

FIGS. 4A and 4B are views illustrating a screen on which highlighting moves when a single-point stroke is detected according to an exemplary embodiment of the present invention. Referring to FIG. 4A, highlighting 415 is displayed on a fifth music file of a music list 412 in a third screen 410. If a user inputs a single-point stroke moving upwards on the touch screen 170, the highlighting 415 moves to a fourth music file of the music list 412 as shown in a fourth screen 415 of FIG. 4B. Although described as highlighting the fourth music file of the music list 412, the highlighting 415 can be moved to highlight any music file of the music list 412 with the single-point stroke.

Specifically, the single-point stroke causes the highlighting 415 to move in the direction of the stroke, and the multipoint stroke causes the music album list 325 higher than the music list 312 currently being displayed to appear.

According to the exemplary embodiment of the present invention, the single-point stroke has a function different from that of the multipoint stroke. Accordingly, a user may input various commands using the touch screen 170.

Returning to FIG. 2, if the touch screen 170 detects other types of input instead of the single-point stroke and the multipoint stroke (S230-N), the functions corresponding to the input are performed (S240).

The user may input various commands using the touch screen 170 by inputting the multipoint stroke, the single-point stroke, and other input strokes. In this exemplary embodiment of the present invention, while the multipoint stroke displays a higher list, the multipoint stroke may be implemented to perform other functions.

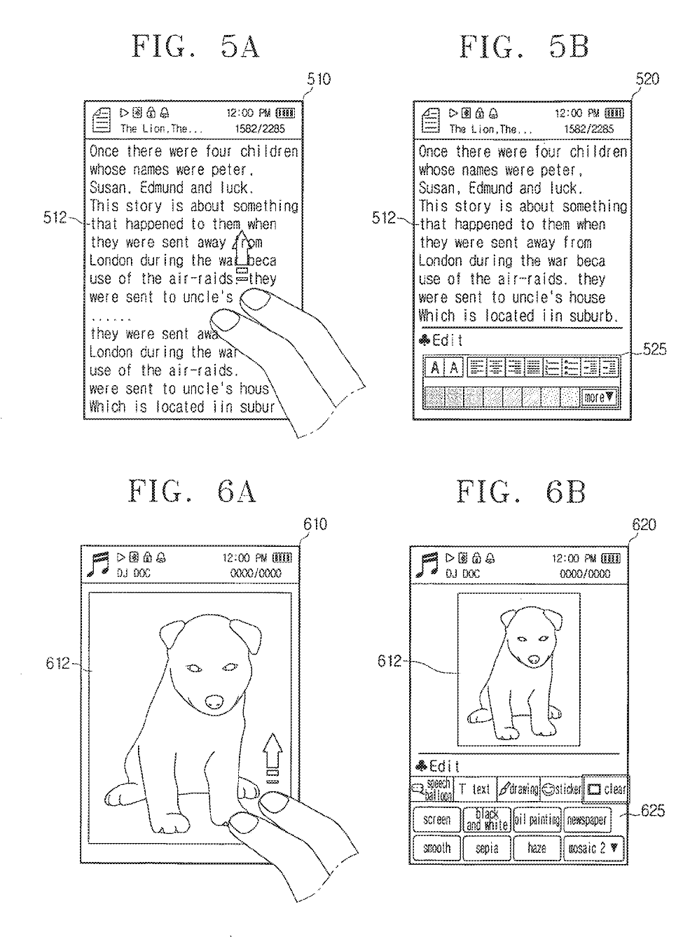

Other functions of the multipoint stroke will be explained with reference to FIGS. 5A to 8B but are not limited thereto.

FIGS. 5A and 5B are views illustrating a screen on which a text mode menu is displayed when a multipoint stroke is detected according to an exemplary embodiment of the present invention. Referring to FIGS. 5A and 5B, text 512 is displayed on a fifth screen 510. If a user inputs the multipoint stroke on fifth screen 510, a text mode menu 525 is displayed as shown on a sixth screen 520 in FIG. 5B.

A user may edit the text 512 using the text mode menu 525. For example, the user may use the text mode menu 525 to change the color a portion of the text 512 or make a portion of the text 512 bold. Accordingly, the user may highlight part of the currently displayed text. The text mode menu 525 is not limited to changing the color or making bold the text 512 such that other editing functions may be included.

FIGS. 6A and 6B are views illustrating a screen on which a photographic mode menu is displayed when a multipoint stroke is detected according to an exemplary embodiment of the present invention. Referring to FIG. 6A, a photograph 612 is displayed on a seventh screen 610. If a user inputs the multipoint stroke on the photograph 612 on the seventh screen 610, a photograph mode menu 625 is displayed as shown on an eighth screen 620 in FIG. 6B.

The user may edit the photograph 612 using the photograph mode menu 625. For example, the user may use the photograph mode menu 625 to correct the brightness, contrast, or the like of the currently displayed photograph 612, or create special effects on the photograph612. Accordingly, the user may edit the currently displayed photograph 612 as desired. Although the photograph 612 is illustrated as being fully displayed on the eighth screen 620 along with the photograph mode menu 625 in FIG. 6B, aspects of the present invention are not limited thereto such that the photograph mode menu 625 may cover a portion of the photograph 612.

According to the foregoing exemplary embodiments of the present invention, the multipoint stroke performs different functions according to the currently supported mode, for example, music mode, text mode, or photograph mode. Specifically, the multipoint stroke displays menus indicating functions which are supported in a current mode of the touch screen 170. Accordingly, the user may call menus which are supported in a current mode by inputting the multipoint stroke.

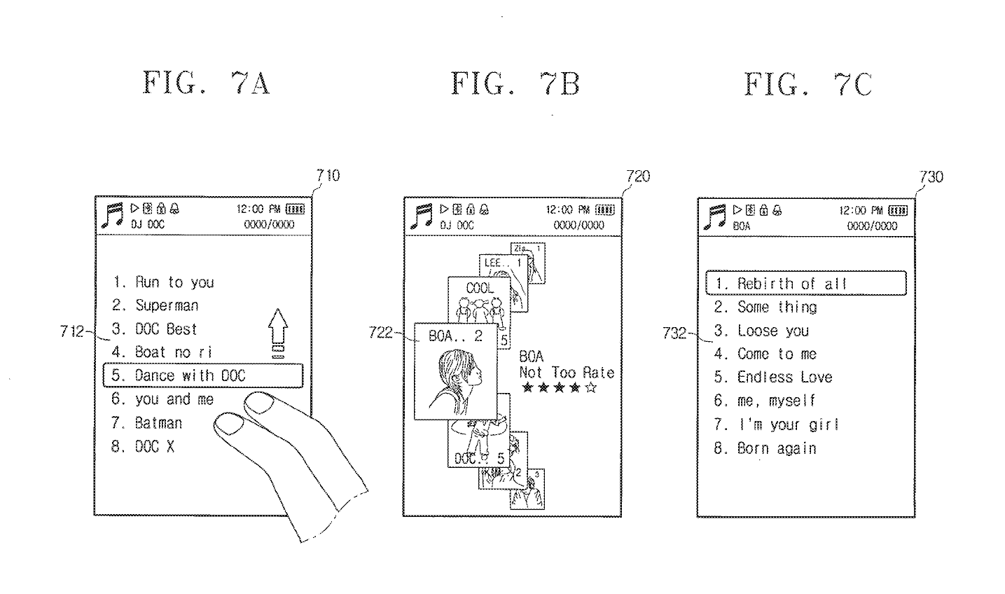

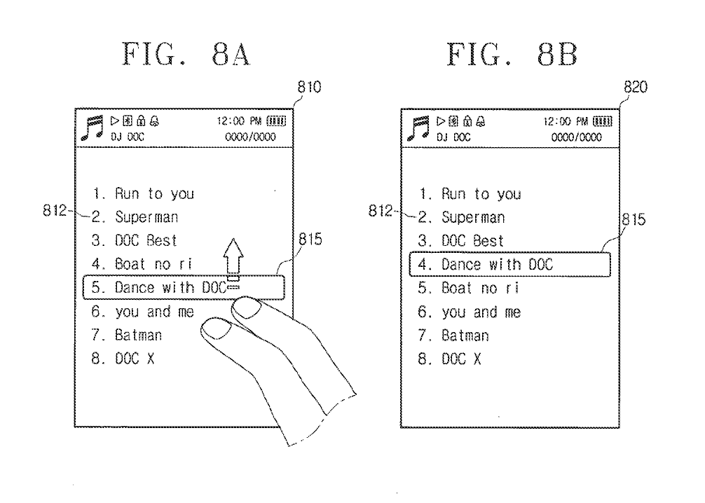

Other functions of the multipoint stroke on the screen displaying the music list will be explained in detail. FIGS. 7A, 7B, and 7C are views illustrating screens on which a user may scroll through a music album list when a multipoint stroke is detected according to an exemplary embodiment of the present invention. Referring to FIG. 7A, a ninth screen 710 displays a music list 712 of a music album ‘OJ DOC.’

According to aspects of the present invention, the multipoint stroke enables a user to scroll through a higher list than the music list 712 displayed on the touch screen 170 as the ninth screen 710.

If a user inputs the multipoint stroke moving upward, the ninth screen 710 on the touch screen 170 is changed to a tenth screen 720 as shown in FIG. 7B. The tenth screen 720 displays a music album list 722 as image icons, and the image icons may scroll in a direction in which the multipoint stroke is input. As the user inputs an upward multipoint stroke on the ninth screen 710, the music album ‘BOA’ positioned above the music album ‘OJ DOC’ is selected. If the multipoint stroke is terminated, a music list 732 of the currently selected music album is displayed as an eleventh screen 730 on the touch screen 170 as shown in FIG. 7C. Accordingly, the eleventh screen 730 displays the music list 732 of the music album ‘BOA.’

Aspects of the present invention may be implemented to scroll through a higher list, i.e., the album list relative to the music list, using a multipoint stroke. Accordingly, the user can select a desired item from among the higher list more conveniently.

The multipoint stroke may carry out other functions. FIGS. 8A and 8B are views illustrating screens on which the position of a selected music file moves when the multipoint stroke is detected, according to an exemplary embodiment of the present invention. Referring to FIG. 8A, a twelfth screen 810 displays a music list 812, and highlighting 815 is displayed on a fifth music file of the music list 812.

According to aspects of the present invention, the multipoint stroke performs the function of moving a music file included in the music list 812 on the touch screen 150 to another location within the music list 812. However, aspects of the present invention are not limited thereto such that the multipoint stroke may move a music file included in the music list 812 to another location, such as another music list.

If the user inputs the multipoint stroke moving upward on the area on which the highlighting 815 is positioned, the highlighted music file moves upward as shown in the music list 812 on a thirteenth screen 820 in FIG. 8B.

If the user inputs the multipoint stroke, the music file on which the highlighting 815 is displayed moves, and thus the position of the music file is changed. Therefore, the user may reconstruct a music list conveniently.

While the multipoint stroke is described using a two-point stroke, a multipoint stroke using three or more strokes may also be applied according to aspects of the present invention. The multipoint stroke according to aspects of the present invention may be implemented to perform other functions. For example, a two-point stroke may perform the functions described in FIGS. 3A and 3B, a three-point stroke may perform the functions described in FIGS. 7A to 7C, and a four-point stroke may perform the functions described in FIGS. 8A and 8B.

The functions corresponding to the multipoint stroke may vary according to the number of strokes concurrently input on the touch screen 170.

While the multipoint stroke is described in the exemplary embodiments of the present invention, any action of flicking the touch screen 170 may be applicable according to aspects of the present inventions.

For example, the function of a drag and drop operation may vary according to whether a single-point or a multipoint stroke is performed. Herein, the drag and drop operation is the action in which a user touches an item displayed on the touch screen 170, drags it to a different location or onto another item, and releases his or her finger from the touch screen 170.

A function of a stroke and hold operation may also vary according to whether a single-point or a multipoint stroke is performed. Herein, the stroke and hold operation is an action in which a user moves his or her finger in a specific direction while touching the touch screen 70, and keeps his or her finger on the touch screen 170.

While the touch screen is described as a touch input device, aspects of the present invention may also be applied to touch input devices other than the touch screen, such as a touch pad.

The MP3 player is provided as an example of a multimedia apparatus in the exemplary embodiments of the present invention, but the present invention may also be applied to any other multimedia apparatuses having a touch input device, such as a portable media player (PMP), a mobile phone, a laptop or a tablet computer, an electronic dictionary, a camera, a personal digital assistant (PDA), a remote control, an automatic teller machine, or the like. Further, aspects of the present invention are not limited such that a user may determine the functions corresponding to the input multipoint or single-point strokes.

While not required, aspects of the invention can be implemented using software and/or firmware encoded in computer readable media to be implemented by one or more processors and/or computers.

As described above, according to aspects of the present invention, a method for providing a UI to perform a function corresponding to a multipoint stroke, and a multimedia apparatus using the same, are provided. Accordingly, a user may use a touch screen using various types of input method more conveniently. As the functions corresponding to the single-point stroke are different from those of a multipoint stroke, the user can use various methods of touch input on a touch device. The functions of the multipoint stroke vary according to the number of strokes so the user can input a greater variety of commands on a touch device.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electronic apparatus, comprising:
a touch screen display to detect a multipoint stroke; and
a control unit responsive to the touch screen display to perform a function corresponding to the multipoint stroke if the multipoint stroke is detected,
wherein the function corresponding to the multipoint stroke is determined according to a number of concurrent touches of the touch screen display in the multipoint stroke.

2. The apparatus of claim 1, wherein the determined function corresponding to the multipoint stroke is distinct from that of a single-point stroke.

3. The apparatus of claim 1, wherein the multipoint stroke comprises a touch of the touch screen at multiple points on the touch screen.

4. The apparatus of claim 1, wherein the control unit controls the touch screen to display items related to currently displayed items at an area in which the multipoint stroke is detected, if the multipoint stroke is performed on the touch screen from an edge of the touch screen toward a center of the touch screen.

5. The apparatus of claim 4, wherein the area expands from the edge of the touch screen in a direction in which the multipoint stroke is performed.

6. The apparatus of claim 1, wherein the determined function corresponding to the multipoint stroke comprises dividing a display area on the touch screen, and displaying the items related to the currently displayed items on the divided area.

7. The apparatus of claim 1, wherein the determined function corresponding to the multipoint stroke comprises displaying higher items or lower items corresponding to an item selected from the items displayed on the touch screen.

8. The apparatus of claim 1, wherein the determined function corresponding to the multipoint stroke comprises displaying a menu of functions supported in a current state of operation of the multimedia apparatus.

9. The apparatus of claim 8, wherein the menu is expanded from an edge of the touch screen opposite to a direction of the multipoint stroke.

10. The apparatus of claim 1, wherein the determined function corresponding to the multipoint stroke comprises scrolling through a list of items of a higher level than a list displayed on the touch screen.

11. The apparatus of claim 10, wherein the list of items of the higher level corresponds to a selected item of the list of items displayed on the touch screen.

12. The apparatus of claim 1, wherein the determined function corresponding to the multipoint stroke comprises changing a location of an item selected from a list displayed on the touch screen within the list.

13. An electronic apparatus, comprising:
a touch input device to detect a multipoint stroke;
a control unit responsive to the input device to perform a function corresponding to the multipoint stroke if the multipoint stroke is detected,
wherein the function corresponding to the multipoint stroke is determined according to a number of concurrent touches of the touch input device in the multipoint stroke

14. The multimedia apparatus of claim 13, wherein the touch input device is a touch pad.
